(19) United States
(12) Patent Application Publication
(10) Pub. No.: US 2026/0176163 A1
(43) Pub. Date: Jun. 25, 2026

(54) MINERALIZATION WATERWAY SYSTEM AND MINERALIZATION WATER PURIFIER

(71) Applicant: Guangdong Lizi Technology Co., Ltd., Foshan (CN)

(72) Inventors: Wenbin Chen, Foshan (CN); Xing Zhan, Foshan (CN); Jiawei Chen, Foshan (CN); Yutai Huang, Foshan (CN); Guoxiang Chen, Foshan (CN); Yijie Hao, Foshan (CN); Jianbo Huang, Foshan (CN); Wei Luo, Foshan (CN); Longbiao He, Foshan (CN)

(21) Appl. No.: 19/021,733

(22) Filed: Jan. 15, 2025

(30) Foreign Application Priority Data
Dec. 19, 2024 (CN) 202411884164.5

(51) Int. Cl. C02F 1/00; C02F 1/02; C02F 1/28; C02F 1/44; C02F 1/469; C02F 1/66; C02F 1/68; C02F 9/00

(52) U.S. Cl. CPC C02F 1/008; C02F 1/006; C02F 9/00; C02F 1/001; C02F 1/02; C02F 1/28; C02F 1/441; C02F 1/442; C02F 1/4693; C02F 1/66; C02F 1/68; C02F 2201/005; C02F 2209/003; C02F 2209/02; C02F 2209/05; C02F 2209/40; C02F 2303/16

(57) ABSTRACT

The present disclosure provides a mineralization waterway system and a mineralization water purifier with a single-channel desalination component and a dual-channel desalination component which are arranged in parallel. The dual-channel desalination component is used for preliminary desalination, and the produced pure water then flows into the single-channel desalination component for further purification, ensuring that the quality of outlet water meets high standards. At the same time as the pure water produced by the dual-channel desalination component flows into the single-channel desalination component, saline substances within the single-channel desalination component are flushed out by the pure water and discharged through a branch pipeline, achieving self-cleaning and regeneration of the single-channel desalination component, thereby prolonging a service life of the single-channel desalination component. The pure water produced by the desalination components then flows into the mineralization filter element unit for mineralization.

### CROSS REFERENCE TO RELATED APPLICATIONS

The present application claims the benefit of Chinese Patent Application No. 202411884164.5 filed on Dec. 19, 2024, the contents of which are incorporated herein by reference in their entirety.

### TECHNICAL FIELD

The present disclosure relates to the technical field of water purification, and particularly to a mineralization waterway system and a mineralization water purifier.

### BACKGROUND

A mineralization water purifier is a type of water purification equipment that can deeply purify tap water and add mineral elements needed by human body, thereby enhancing water quality to achieve standards comparable to mineral water. By incorporating filter materials rich in minerals, the mineralization water purifier re-infuses minerals such as calcium, magnesium, iron, zinc, and other minerals needed by the human body into water. These minerals exist in an ionic state, and are more easily absorbed by the human body.

In existing technologies, reverse osmosis membranes are often used to purify tap water. Reverse osmosis membranes can effectively prevent substances such as bacteria, viruses, scale, salt ions, and so on, allowing only water molecules to pass through, thereby ensuring a safety of water use. After being used for a period of time, a purification effect of the reverse osmosis membranes on tap water becomes weaker, and resulting in poor quality of the produced pure water.

### SUMMARY

In view of this, the embodiment of the present disclosure provides a mineralization waterway system and a mineralization water purifier. By using parallel a single-channel desalination component and a dual-channel desalination component, water purified by the dual-channel desalination component is used to flush and regenerate the single-channel desalination component, thereby prolonging a service life of the single-channel desalination component and improving a quality of the produced pure water.

A first aspect of the present disclosure provides a mineralization waterway system, including:
a water inlet pipeline, a water outlet pipeline, and a branch pipeline;
a single-channel desalination component and a dual-channel desalination component which are arranged in parallel; wherein the single-channel desalination component includes a first port and a second port, the dual-channel desalination component includes a water inlet side and a water outlet side, the first port and the water inlet side are arranged in parallel, the second port and the water outlet side are arranged in parallel;
a mineralization filter element unit;
wherein the water inlet pipeline is connected to the first port and the water inlet side, pure water flowing out of the second port and the water outlet side flows into the mineralization filter element unit for mineralization, and the mineralized water filtered out by the mineralization filter element unit flows out through the water outlet pipeline; the branch pipeline is connected to the first port; the dual-channel desalination component purifies the water flowing in through the water inlet side, and the pure water flows into the single-channel desalination component through the water outlet side and the second port, and salt substances within the single-channel desalination component are flushed by the pure water and then flow into the branch pipeline through the first port.

Optionally, further including a waterway switching device, wherein the waterway switching device is connected to the first port, when a forward voltage is applied to the single-channel desalination component and the waterway switching device is switched to the water inlet pipeline, the single-channel desalination component purifies water flowing out through the water inlet pipeline and the first port, and the purified water flows out to the mineralization filter element unit through the second port; when the single channel desalination component is powered off or a reverse voltage is applied to the single-channel desalination component, and the waterway switching device is switched to the branch pipeline, the salt substances within the single-channel desalination component are flushed by the water flowing out through the water outlet side and the second port and then flow into the branch pipeline.

Optionally, further including a power supply member and a control member, wherein the control member is configured to control the power supply member to disconnect the power supply to the single-channel desalination component or apply a reverse voltage to the single-channel desalination component, and also to control the waterway switching device to switch to the branch pipeline.

Optionally, further including filtration members, wherein the filtration members are installed on the water inlet pipeline and/or the water outlet pipeline, and/or on one side of the first port of the single-channel desalination component, and/or on one side of the second port of the single-channel desalination component.

Optionally, further including conductivity detection members, wherein the conductivity detection members are installed on the water inlet pipeline and/or the water outlet pipeline, and/or on the branch pipeline, and/or on one side of the second port of the single-channel desalination component, and/or on one side of the water outlet side of the dual-channel desalination component.

Optionally, further including a drive member, wherein the drive member is configured to drive water flow towards the single-channel desalination component and the dual-channel desalination component.

Optionally, further including a heating member, wherein the heating member is installed on the outlet water pipeline, and configured to heat water flowing out from the outlet water pipeline.

Optionally, further including a temperature detection member, wherein the temperature detection member is installed on the water outlet pipeline, and configured to detect a temperature of the water flowing out from the outlet water pipeline.

Optionally, further including a water flow rate detection member, wherein the water flow rate detection member is installed on the water inlet pipeline and/or the water outlet pipeline.

Optionally, further including conductivity detection members, wherein the conductivity detection members are installed upstream and downstream of the mineralization filter element unit, for real-time detection of conductivity value upstream and downstream of the mineralization filter element unit.

Optionally, wherein the mineralization filter element unit includes a mineralization pipeline, and a mineralization filter element is arranged on the mineralization pipeline.

Optionally, wherein the mineralization filter element unit includes: a mineralization pipeline and an inhibition pipeline which are arranged in parallel and capable of simultaneously or separately discharging water; the mineralization pipeline is provided with a mineralization filter element; the inhibition pipeline is provided with an inhibition filter element; a serially-connected switching pipeline is arranged between the mineralization pipeline and the inhibition pipeline; the serially-connected switching pipeline is configured to connect the inhibition filter element to the mineralization filter element in series; an output side of the serially-connected switching pipeline is connected to the mineralization pipeline or the mineralization filter element; an input side of the serially-connected switching pipeline is connected to the inhibition pipeline or the inhibition filter element; and a control valve is arranged on the serially-connected switching pipeline.

Optionally, wherein the mineralization filter element includes a zinc-containing filter material; and the inhibition filter element includes an alkaline filter material.

Optionally, wherein the mineralization filter element includes a first alkaline filter material; the inhibition filter element includes a second alkaline filter material; and the second alkaline filter material is configured to inhibit dissolution of an alkaline substance from the first alkaline filter material.

Optionally, wherein the mineralization filter element unit includes: a mineralization pipeline and an acceleration pipeline which are arranged in parallel and capable of simultaneously or separately discharging water; the mineralization pipeline is provided with a mineralization filter element; the acceleration pipeline is provided with an acceleration filter element; a serially-connected switching pipeline is arranged between the mineralization pipeline and the acceleration pipeline; the serially-connected switching pipeline is configured to connect the acceleration filter element to the mineralization filter element in series; an output side of the serially-connected switching pipeline is connected to the mineralization pipeline or the mineralization filter element; an input side of the serially-connected switching pipeline is connected to the acceleration pipeline or the acceleration filter element; and a control valve is arranged on the serially-connected switching pipeline.

Optionally, wherein the mineralization filter element includes a metasilicic-acid-containing filter material, and the acceleration filter element includes an alkaline filter material.

Optionally, wherein the mineralization filter element includes maifanite, and the acceleration filter element includes periclase.

Optionally, wherein the mineralization filter element unit includes: a mineralization pipeline, an inhibition pipeline, and an acceleration pipeline which are arranged in parallel and capable of simultaneously or separately discharging water; the mineralization pipeline is provided with a mineralization filter element; the inhibition pipeline is provided with an inhibition filter element; the acceleration pipeline is provided with an acceleration filter element; a first connection pipeline is arranged between the mineralization pipeline and the inhibition pipeline; an output side of the first connection pipeline is connected to the mineralization pipeline or the mineralization filter element; an input side of the first connection pipeline is connected to the inhibition pipeline or the inhibition filter element; a first control valve is arranged at the first connection pipeline; a second connection pipeline is arranged between the mineralization pipeline and the acceleration pipeline; an output side of the second connection pipeline is connected to the mineralization pipeline or the mineralization filter element; an input side of the second connection pipeline is connected to the acceleration pipeline or the acceleration filter element; and a second control valve is arranged at the second connection pipeline.

Optionally, wherein the mineralization filter element includes a metasilicic-acid-containing filter material; the acceleration filter element includes an alkaline filter material; and the inhibition filter element includes a zeolite filter material.

A second aspect of the present disclosure provides a mineralization water purifier including the mineralization waterway system.

The mineralization waterway system and the mineralization water purifier provided in the embodiments of the present disclosure with a single-channel desalination component and a dual-channel desalination component which are arranged in parallel. Firstly, the dual-channel desalination component is used for preliminary desalination, and the produced pure water then flows into the single-channel desalination component for further purification, ensuring that the quality of the outlet water meets high standards. At the same time as the pure water produced by the dual-channel desalination component flows into the single-channel desalination component, the saline substances within the single-channel desalination component are flushed out by the pure water and discharged through a branch pipeline, achieving self-cleaning and regeneration of the single-channel desalination component, thereby prolonging a service life of the single-channel desalination component. The pure water produced by the desalination components then flows into the mineralization filter element unit for mineralization. The mineralization filter element unit is capable of adding beneficial minerals to the pure water, so that the outlet water is not only pure but also rich in mineral elements beneficial to the human body, improving the quality and taste of the drinking water.

### BRIEF DESCRIPTION OF THE DRAWINGS

To describe the technical solutions in the embodiments of the present disclosure or in the related art more clearly, the following briefly introduces the accompanying drawings for describing the embodiments or the related art. Apparently, the accompanying drawings in the following description show merely some of the embodiments of the present disclosure, and a person of ordinary skill in the art can still derive other drawings from the accompanying drawings without creative efforts.

FIG. 1 is a schematic structural diagram of a mineralization waterway system according to an embodiment of the present disclosure.

FIG. 2 is a schematic structural diagram of another mineralization waterway system according to an embodiment of the present disclosure.

FIG. 3 is a schematic structural diagram of still another mineralization waterway system according to an embodiment of the present disclosure.

FIG. 4 is a schematic structural diagram of a connection relationship of a control member according to an embodiment of the present disclosure.

FIG. 5 is a schematic structural diagram of a mineralization filter element unit according to an embodiment of the present disclosure.

FIG. 6 is a schematic structural diagram of another mineralization filter element unit according to an embodiment of the present disclosure.

FIG. 7 is a schematic structural diagram of still another mineralization filter element unit according to an embodiment of the present disclosure.

FIG. 8 is a schematic structural diagram of yet another mineralization filter element unit according to an embodiment of the present disclosure.

FIG. 9 is a schematic structural diagram of a mineralization water purifier according to an embodiment of the present disclosure;

### DETAILED DESCRIPTION OF THE EMBODIMENTS

The technical solutions in the embodiments of the present disclosure are clearly and completely described below with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without making creative efforts shall fall within the protection scope of the present disclosure.

Please refer to FIG. 1, a mineralization waterway system 1 includes: a water inlet pipeline 100, a single-channel desalination component 200 and a dual-channel desalination component 300 which are arranged in parallel, a mineralization filter element unit 400, and a water outlet pipeline 500.

The single-channel desalination component 200 includes: a first port 210 and a second port 220. When a forward voltage is applied, water flowing into the first port 210 is purified, and the purified water flows out through the second port 220 into the mineralization filter element unit 400. The dual-channel desalination component 300 includes: a water inlet side 310 and a water outlet side 320. When a driving pressure is applied, water flowing into the water inlet side 310 is purified, and the purified water flows out through the water outlet side 320 into the mineralization filter element unit 400. The mineralization filter element unit 400 is connected to a water outlet pipeline 500. In some embodiments, the single-channel desalination component 200 can include a physical adsorption desalination filter element and/or a chemical adsorption desalination filter element. The dual-channel desalination component 300 can include at least one of a Reverse Osmosis (RO) filter element, a nanofiltration membrane filter element, and an electrodialysis membrane filter element.

The water inlet pipeline 100 is connected to the first port 210 and the water inlet side 310, with the first port 210 and the water inlet side 310 arranged in parallel. The water outlet pipeline 500 is connected to the second port 220 and the water outlet side 320, with the second port 220 and the water outlet side 320 arranged in parallel.

In an optional embodiment, the mineralization waterway system 1 further includes: a branch pipeline 600. The branch pipeline 600 is connected to the first port 210.

The water inlet pipeline 100 supplies water to both the first port 210 and the water inlet side 310. The purified water from the single-channel desalination component 200 and the dual-channel desalination component 300 flows into the mineralization filter element unit 400. The water outlet pipeline 500 is used to output the mineralized water produced by the mineralization filter element unit 400. When flushing and regenerating the single-channel desalination component 200, the dual-channel desalination component 300 purifies the water flowing in through the water inlet side 310. The purified water then flows into the single-channel desalination component 200 through the water outlet side 320 and the second port 220 of the single-channel desalination component 200. By powering off or applying a reverse voltage to the single-channel desalination component 200, saline substances within the single-channel desalination component 200 are flushed out by the purified water flowing out from the second port 220 and then flow into the branch pipeline 600 through the first port 210.

A first solenoid valve can be installed on the water outlet pipeline 500, a second solenoid valve can be installed on the branch pipeline 600, and a third solenoid valve can be installed on a side of the first port 210 of the parallel branch where the single-channel desalination component 200 is located. During water production, a forward voltage is applied to the single-channel desalination component 200, and the first solenoid valve and the third solenoid valve are opened. Water from the water inlet pipeline 100 flows into the single-channel desalination component 200 through the third solenoid valve. The single-channel desalination component 200 purifies the water, and the purified water is output to the mineralization filter element unit 400 through the second port 220 and the first solenoid valve. At the same time, water from the water inlet pipeline 100 flows into the dual-channel desalination component 300 through the water inlet side 310. The dual-channel desalination component 300 purifies the water, and the purified water is output to the mineralization filter element unit 400 through the water outlet side 320 and the first solenoid valve.

During the flushing and regeneration of the single-channel desalination component 200, the single-channel desalination component 200 is deactivated or reversed in voltage, the first solenoid valve is closed, while the second solenoid valve and the third solenoid valve are opened. Water from the water inlet pipeline 100 flows into the dual-channel desalination component 300 through the water inlet side 310. The dual-channel desalination component 300 purifies the water, and the purified water flows into the single-channel desalination component 200 through the water outlet side 320 and the second port 220. The saline substances within the single-channel desalination component 200 are flushed out by the purified water flowing out from the second port 220 and then flow into the branch pipeline 600 through the first port 210 and the second solenoid valve.

By purifying water through the dual-channel desalination component 300 and allowing the purified water to flow into the single-channel desalination component 200 for flushing and regeneration, a risk of scaling during the regeneration of the single-channel desalination component 200 is reduced compared to using tap water for flushing and regeneration. This prolongs the service life of the single-channel desalination component 200 and improves the quality of the produced pure water.

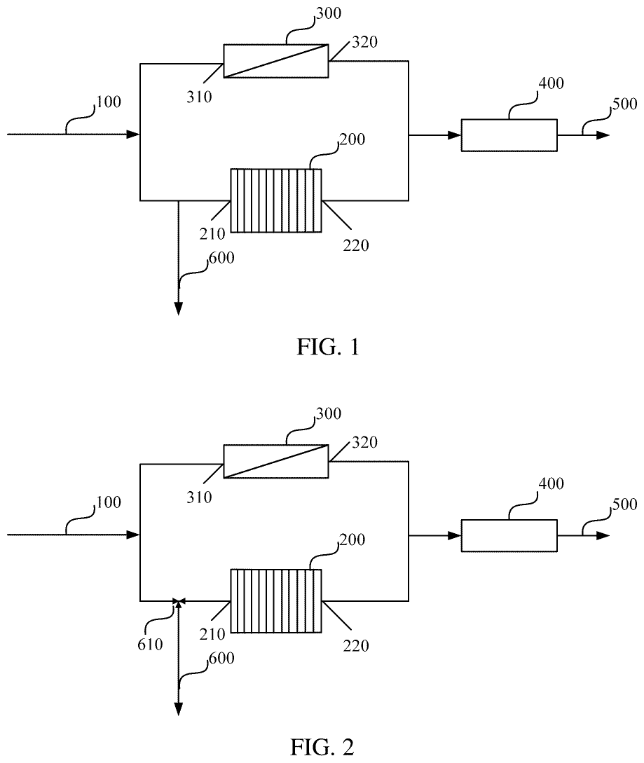

As shown in FIG. 2, the mineralization waterway system 1 further includes a waterway switching device 610, which is connected to the first port 210.

In one embodiment, the waterway switching device 610 can include a tangential valve or a group of two-way solenoid valves, such as three-way valves, etc.

During a water purification process of the single-channel desalination component 200, a forward voltage is applied to the single-channel desalination component 200, and the waterway switching device 610 is switched to the water inlet pipeline 100. The water input from the water inlet pipeline 100 and flowing in through the first port 210 is purified. The purified water then flows out through the second port 220 and into the mineralization filter element unit 400.

During the flushing and regeneration of the single-channel desalination component 200, the single-channel desalination component 200 is deactivated or reversed in voltage, and the waterway switching device 610 is switched to the branch pipeline 600. The dual-channel desalination component 300 purifies the water, and the purified water flows into the single-channel desalination component 200 through the water outlet side 320 and the second port 220. The saline substances within the single-channel desalination component 200 are flushed out by the purified water and then flow into the branch pipeline 600.

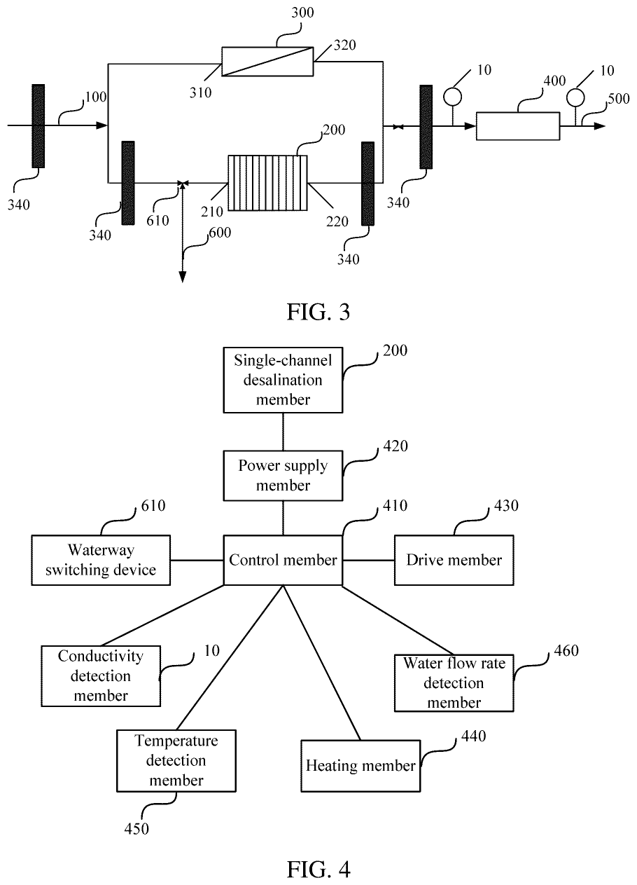

As shown in FIG. 3, the mineralization waterway system 1 further includes filtration members 340. The filtration members 340 can be installed on the water inlet pipeline 100 and/or the water outlet pipeline 500, and/or on one side of the first port 210 of the single-channel desalination component 200, and/or on one side of the second port 220 of the single-channel desalination component 200.

By installing the filtration member 340 on the water inlet pipeline 100, the water entering the single-channel desalination component 200 and dual-single-channel desalination component can be filtered, such as removing particles, impurities, residual chlorine, and other impurities in the water, thereby reducing workload and consumption of the single-channel desalination component 200 and the dual-single-channel desalination component 300, and prolonging their regeneration cycles and service life.

By installing the filtration member 340 on the water outlet pipeline 500, the water quality of the purified water outputted by the mineralization waterway system 1 can be further improved.

By installing the filtration member 340 on the one side of the first port 210 of the single-channel desalination component 200, the water outputted from the water inlet pipeline 100 can first be filtered through the filtration member 340 before flowing into the single-channel desalination component 200 through the first port 210 for purification.

By installing the filtration member 340 on the one side of the second port 220 of the single-channel desalination component 200 (i.e., between the second port 220 and the water outlet side 320), the water outputted from the water inlet pipeline 100 can first flow into single-channel desalination component 200 for purification. The purified water is then filtered by the filtering member 340 and flows into the mineralization filter element unit 400. When the single-channel desalination component 200 is deactivated or reversed in voltage, the pure water purified by the dual-channel desalination component 300 passes through the filtration member 340 for reverse flushing, and then flows into the single-channel desalination component 200 through the second port 220, to flush the salt substances within the single-channel desalination component 200 to the branch pipeline 600.

In one embodiment, the filtering member 340 can include a physical retention function filter element and/or a physical adsorption function filter element. The physical retention function filter element includes at least one of a microfiltration membrane, an ultrafiltration membrane, and a PP cotton filter element. The physical adsorption function filter element includes at least one of an activated carbon particles and an activated carbon rod.

As shown in FIG. 3, the mineralization waterway system 1 further includes: conductivity detection members 10. The conductivity detection members 10 can be installed on the water inlet pipeline 100 and/or the water outlet pipeline 500, or on the branch pipeline 600, and/or on one side of the second port 220 of the single-channel desalination component 200, and/or on one side of the water outlet side 320 of the dual-channel desalination component 300. The conductivity detection member 10 can include a conductivity detector and a TDS (Total Dissolved Solids) detector.

By installing the conductivity detection member 10 on the water inlet pipeline 100 and/or the water outlet pipeline 500, water quality at corresponding locations can be detected. For example, TDS (Total Dissolved Solids) value is a water quality detection indicator specifically designed for purified water, representing a content of dissolved total solids in water. The TDS value can reflect the water quality to a certain extent. Generally, the lower the TDS value, the less soluble saline substances such as heavy metal ions in the water and the purer the water quality.

By installing the conductivity detection member 10 on the branch pipeline 600, a conductivity on the branch pipeline 600 can be detected when the single-channel desalination component 200 is powered off or a reverse voltage is applied to the single-channel desalination component 200, thereby determining a regeneration effect of the single-channel desalination component 200. For example, when a conductivity value detected by the conductivity detection member 10 is less than a preset conductivity value, it can be determined that the saline substances within the single-channel desalination component 200 have been fully flushed out. At this point, the regeneration mode can be terminated, an application of the forward voltage to the single-channel desalination component 200 can be resumed, and the waterway switching device 610 can be controlled to switch back to the water inlet pipeline 100.

By installing the conductivity detection member 10 on the one side of the second port 220 of the single-channel desalination component 200, a conductivity value of water outputted from the single-channel desalination component 200 can be detected, thereby determining whether a water purification effect of the single-channel desalination component 200 meets required standards. For example, when a conductivity value detected by the conductivity detection member 10 is higher than a target conductivity or when a duration of being higher than the target conductivity exceeds a preset duration, it can be determined that the single-channel desalination component 200 needs regeneration treatment. Similarly, by installing the conductivity detection member 10 on the one side of the water outlet side 320 of the dual-channel desalination component 300, a conductivity value of water outputted from the dual-channel desalination component 300 can be detected, thereby determining whether a water purification effect of the dual-channel desalination component 300 meets the required standards. For example, when a conductivity value detected by the conductivity detection member 10 is higher than a target conductivity or when a duration of being higher than the target conductivity exceeds a preset duration, it can be determined that the dual-channel desalination component 300 needs regeneration treatment.

In one embodiment, as illustrated in FIG. 4, the mineralization waterway system 1 can further include: a control member 410, a power supply member 420, and a drive member 430. The control member 410 is connected to the conductivity detection member 10, the power supply member 420, the drive member 430, and the waterway switching device 610. The power supply member 420 is connected to the single-channel desalination component 200 to apply a forward voltage or a reverse voltage to the single-channel desalination component 200. The drive member 430 drives the water flow towards the single-channel desalination component 200 and the dual-channel desalination component 300.

In one embodiment, the drive member 430 can include a pressure pump. The control member 410 can include a microcontroller, etc.

In some embodiments, when switching to the regeneration mode during a preset time period, such as from 10:00 PM to 10:30 PM, the control member 410 controls the power supply member 420 to disconnect the power supply to the single-channel desalination component 200 or to apply a reverse voltage to the single-channel desalination component 200. Simultaneously, the control member 410 controls the waterway switching device 610 to switch to the branch pipeline 600. During this period, the dual-channel desalination component 300 performs water purification, and the produced pure water flows into the single-channel desalination component 200 through the water outlet side 320 and the second port 220, so that salt ions attached to the single-channel desalination component 200 enter the water and are discharged from the single-channel desalination component 200 with the water.

In one embodiment, when the conductivity value detected by the conductivity detection member 10 on the one side of the second port of the single-channel desalination component 200 is higher than the target conductivity, the control member 410 controls the power supply member 420 to disconnect the power supply to the single-channel desalination component 200 or to apply a reverse voltage to the single-channel desalination component 200. Simultaneously, the control member 410 controls the waterway switching device 610 to switch to the branch pipeline 600, so that salt ions attached to the single-channel desalination component 200 enter the water and are discharged from the single-channel desalination component 200 with the water. Flushed wastewater is then discharged from the first port 210 of the single-channel desalination component 200 to the branch pipeline 600.

In one embodiment, the control member 410 can also control the power supply member 420 to adjust the supply voltage to the single-channel desalination component 200 based on the conductivity value detected by the conductivity detection member 10 on the water inlet pipeline 100. For example, the higher the conductivity value detected by the conductivity detection member 10 on the water inlet pipeline 100, the greater the forward voltage applied by the power supply member 420 to the single-channel desalination component 200 to improve the purification effect.

In some embodiments, the mineralization waterway system 1 can further include one or more of the following combinations: a heating member 440, a temperature detection member 450, and a water flow rate detection member 460.

The heating member 440 can be installed in a water outlet direction of the outlet water pipeline 500, and configured to heat water flowing out from the outlet water pipeline 500 to provide users with hot water at a desired temperature. The heating member 440 can include heat exchangers.

The temperature detection member 450 can be installed on the water outlet pipeline 100, and configured to detect a temperature of the water flowing out from the outlet water pipeline 500. The temperature detection member 450 also can be installed on the water inlet pipeline 100, and configured to detect a temperature of water flowing towards the single-channel desalination component 200 and the dual-channel desalination component 300.

The water flow rate detection member 460 can be installed on the water inlet pipeline 100 and/or the water outlet pipeline 500.

The mineralization waterway system 1 provided in the embodiments includes the single-channel desalination component and the dual-channel desalination component arranged in parallel. The single-channel desalination component includes the first port and the second port, while the dual-channel desalination component includes the water inlet side and the water outlet side. The first port is connected in parallel with the water inlet side, and the second port is connected in parallel with the water outlet side. The water inlet pipeline is connected to the first port and the water inlet side, the mineralization filter element unit is connected to the second port and the water outlet side, and the branch pipeline is connected to the first port. The dual-channel desalination component purifies the water flowing in through the water inlet side, and the produced pure water flows into the single-channel desalination component through the water outlet side and the second port. The salt substances within the single-channel desalination component are flushed by the inflowing pure water and then flow into the branch pipeline through the first port. By using the pure water purified by the dual-channel desalination component to flush and regenerate the single-channel desalination component, the risk of scaling during the regeneration of the single-channel desalination component is reduced, and the quality of the produced pure water is improved.

Since the single-channel desalination component 200 and the dual-channel desalination component 300 filter out all substances in the water, the resulting pure water, devoid of any beneficial elements, cannot be considered as healthy and good water in a certain sense, and does not meet a concept of healthy and good water. Therefore, the present disclosure employs a mineralization filter element unit 400 to mineralize the purified water, thereby producing mineralized water that is beneficial to the human body.

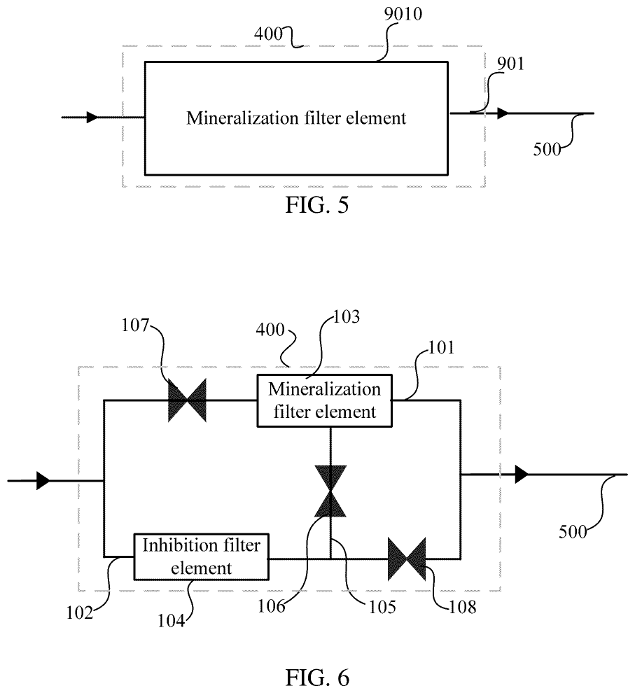

Referring to FIG. 5, the mineralization filter element unit 203 includes a mineralization pipeline 901, and a mineralization filter element 9010 is arranged on the mineralization pipeline 901.

The mineralization pipeline 901 is a channel through which water flows, to ensure smooth and efficient flowing through of water, without introducing any pollutants.

The mineralization filter element 9010 is responsible for adding beneficial minerals into water, to enhance the taste and nutritional value of the water. The mineralization filter element 9010 can be made of various materials, including but not limited to maifanite, tourmaline, weakly alkaline mineralization spheres, and the like.

In practical applications, when flowing through the mineralization filter element unit 203, pure water flowing out of a pure water side of the first filter element unit 30 and/or the second filter element unit 40, pure water can first enter the mineralization pipeline 901 and then flow through the mineralization filter element 9010. The water is in contact with and exchanges with a material in the mineralization filter element 9010, thereby absorbing beneficial minerals. After mineralization, the taste and nutritional value of the water can be improved, so that the water is more suitable for drinking.

As shown in FIG. 6, the mineralization filter element unit 203 includes a mineralization pipeline 101 and an inhibition pipeline 102. The mineralization pipeline 101 is provided with a mineralization filter element 103, and the inhibition pipeline 102 is provided with an inhibition filter element 104.

In an optional embodiment, the mineralization pipeline 101 and the inhibition pipeline 102 are arranged in parallel and can simultaneously output water. Specifically, the mineralization pipeline 101 and the inhibition pipeline 102 are connected in parallel between the water inlet pipeline 109 of the mineralization filter element unit 203 and the water outlet pipeline 60 of the mineralization filter element unit 203. The water inlet pipeline 109 can be connected to the mineralization pipeline 101 and the inhibition pipeline 102 through a three-way valve or a flow divider valve, and the mineralization pipeline 101 and the inhibition pipeline 102 can be connected to the water outlet pipeline 60 through a three-way valve. When the mineralization pipeline 101 and the inhibition pipeline 102 simultaneously output water, the water from the mineralization pipeline 101 and the inhibition pipeline 102 can be mixed and then discharged through the water outlet pipeline 60.

The mineralization filter element 103 is arranged in the mineralization pipeline 101, and the mineralization filter element 103 can release (dissolve) minerals into the water flowing therethrough, thereby making the water output from the mineralization pipeline 101 contain minerals, to meet a requirement of people for mineralized water. The inhibition filter element 104 is arranged in the inhibition pipeline 102, and the inhibition filter element 104 can release an inhibitory substance into the water flowing therethrough. When the water containing the inhibitory substance flows through the mineralization filter element 103, the inhibitory substance can inhibit the dissolution of the minerals in the mineralization filter element 103, thereby avoiding a situation that the mineral content of the water is high.

In an optional embodiment, the mineralization filter element unit 203 further includes a serially-connected switching pipeline 105. The serially-connected switching pipeline 105 is arranged between the mineralization pipeline 101 and the inhibition pipeline 102 and is configured to connect the inhibition filter element 104 to the mineralization filter element 103 in series. An output end of the serially-connected switching pipeline 105 is connected to the mineralization pipeline 101 or the mineralization filter element 103, and an input end of the serially-connected switching pipeline 105 is connected to the inhibition pipeline 102 or the inhibition filter element 104.

The output end of the serially-connected switching pipeline 105 is connected to the mineralization pipeline 101 or the mineralization filter element 103, and the input end of the serially-connected switching pipeline 105 is connected to the inhibition pipeline 102 or the inhibition filter element 104, so that a mineralization structure in which the inhibition filter element 104 is located upstream and the mineralization filter element 103 is located downstream can be formed, and the water containing the inhibitory substance is made to flow through a waterway of the mineralization filter element 103.

In specific implementation, to prevent a high mineral content of the water, the water containing the inhibitory substance can flow through the mineralization filter element 103 through the serially-connected switching pipeline 105 to inhibit the release of the minerals from the mineralization filter element 103 and meet a requirement for reducing the mineral content of the water. When the mineralization filter element 103 is in a soaked state, for example, if the water in the mineralization pipeline 101 flows too slowly, or if outputting of water stops, or after outputting of water stops for a set duration, it can cause the mineral content of the water (especially in the mineralization filter element 103) to be too high. By using the serially-connected switching pipeline 105, the water containing the inhibitory substance can enter the mineralization filter element 103, thereby inhibiting the mineralization filter element 103 in the soaked state from releasing minerals and avoiding an excessive mineral content of the water. The soaked state described in this embodiment means a situation that a flow rate in the filter element is less than a design threshold, including a situation that water stops flowing, the flowing is slow, or the like.

In an optional embodiment, a first control valve 106 is arranged at the serially-connected switching pipeline 105.

The first control valve 106 has a state of allowing water to flow through and a state of not allowing water to flow through. In specific applications, the first control valve 106 can also be a flow valve. Since the first control valve 106 is arranged at the serially-connected switching pipeline 105, it is possible to control whether the water can flow through the serially-connected switching pipeline 105 from the inhibition filter element 104 to the mineralization filter element 103. For example, when the mineralization filter element 103 is in the soaked state, the first control valve 106 can be made in the state of allowing water to flow through. Therefore, the water can flow from the inhibition filter element 104 to the mineralization filter element 103 through the serially-connected switching pipeline 105, thereby inhibiting the mineralization filter element 103 from releasing the minerals, to reduce the mineral content of the water, prevent the mineral content from exceeding a set standard, and control the mineral content in a safe standard range. When a flow rate of the water flowing through the mineralization pipeline 101 exceeds a set flow rate, a concentration of the minerals in the water flowing through the mineralization filter element 103 cannot exceed a set standard. When the mineral content of the water does not need to be reduced, the first control valve 106 can be made in the state of not allowing water to flow through.

In an optional embodiment, the mineralization filter element unit 203 further includes a second control valve 107. The second control valve 107 is arranged at the mineralization pipeline 101 and is located at an upstream end of the mineralization filter element 103.

The second control valve 107 is configured to control the mineralization pipeline 101 to be in a connected or disconnected state and/or control a flow rate of the mineralization pipeline 101. By controlling opening or closing of the second control valve 107, it is possible to determine whether to convey water to the mineralization filter element 103. The flow rate of the mineralization pipeline 101 is controlled through the second control valve 107, so that an amount of minerals released by the mineralization filter element 103 into water per unit volume can be controlled. Specifically, when the flow rate of water in the mineralization pipeline 101 is greater than a set flow rate, the mineral content of water per unit volume can decrease. When the flow rate of water in the mineralization pipeline 101 is less than the set flow rate, the mineral content of water per unit volume can increase. Therefore, the flow rate of the mineralization pipeline 101 can be adjusted through the second control valve 107, thereby adjusting the mineral content of the water in the mineralization pipeline 101.

The output end of the serially-connected switching pipeline 105 is connected between the second control valve 107 and the mineralization filter element 103. In this way, the output end of the serially-connected switching pipeline 105 is connected to an upstream end of the mineralization filter element 103, which can achieve flowing of water in the serially-connected switching pipeline 105 to the mineralization filter element 103.

In an optional embodiment, the mineralization filter element unit 203 further includes a third control valve 108. The third control valve 108 is arranged at the inhibition pipeline 102 and is located at a downstream end of the inhibition filter element 104.

The third control valve 108 is configured to control the inhibition pipeline 102 to be in a connected or disconnected state and/or control a flow rate of the inhibition pipeline 102. The input end of the serially-connected switching pipeline 105 is connected between the inhibition filter element 104 and the third control valve 108. In this way, the input end of the serially-connected switching pipeline 105 is connected to the downstream end of the inhibition filter element 104. When the third control valve 108 is closed, and the first control valve 106 is opened, the water containing the inhibitory substance can flow to the serially-connected switching pipeline 105, and then the water containing the inhibitory substance flows to the mineralization filter element 103.

By controlling the opening or closing of the second control valve 107 and the opening or the closing of the third control valve 108, as well as controlling the state of the first control valve 106 of whether to allow water to flow through, it is possible to achieve that the mineralization pipeline 101 and the inhibition pipeline 102 output water simultaneously or separately, and the water flowing through the inhibition filter element 104 can enter the mineralization filter element 103 through the serially-connected switching pipeline 115.

For example, when the mineralization pipeline 101 and the inhibition pipeline 102 need to output water simultaneously, the second control valve 107 and the third control valve 108 can be controlled to be opened, and the first control valve 106 can be closed. In this case, the serially-connected switching pipeline 105 is blocked, and the mineralization pipeline 101 and the inhibition pipeline 102 are connected in parallel. The water containing the minerals in the mineralization pipeline 101 and the water containing the inhibitory substance in the inhibition pipeline 102 can be mixed in the water outlet pipeline 60 and then discharged.

For another example, when the mineralization pipeline 101 needs to output water separately, the second control valve 107 can be controlled to be opened, and the first control valve 106 and the third control valve 108 can be closed. In this case, the mineralization pipeline 101 is unblocked, and the inhibition pipeline 102 and the serially-connected switching pipeline 105 are both blocked. The water containing the minerals in the mineralization pipeline 101 can be discharged through the water outlet pipeline 60.

For still another example, when the mineralization filter element 103 is in the soaked state, the second control valve 107 and the third control valve 108 can be controlled to be closed, and the first control valve 106 can be opened. In this case, the inhibition filter element 104 and the mineralization filter element 103 are connected to each other through the serially-connected switching pipeline 105, and the water containing the inhibitory substance can flow to the mineralization filter element 103 through the serially-connected switching pipeline 105.

In an optional embodiment, the first control valve 106, the second control valve 107, and the third control valve 108 are all electromagnetic valves. Of course, in other embodiments, the first control valve 106, the second control valve 107, and the third control valve 108 can further use other valves.

In an optional embodiment, the mineralization filter element 103 includes a zinc-containing filter material (e.g., smithsonite and hydrozincite), and the inhibition filter element 104 includes an alkaline filter material (e.g., magnesite, brucite, sepiolite, and calcite). Zinc plays an indispensable role in cell replication, immune activity, and tissue repair and growth, and is a key element in growth, reproductive genetics, immune systems, and bone metabolism. Therefore, configuring the mineralization filter element 103 to include the zinc-containing filter material can release mineral zinc into water, which is beneficial to the health of people. In addition, water with a pH value between 7.0 and 9.0 is the best for the health of a human body. Configuring the inhibition filter element 104 to include the alkaline filter material is beneficial for maintaining the water within the pH range of 7.0 to 9.0.

It should be noted that zinc is one of the essential trace elements for the human body, and it helps growth and can further participate in vitamin metabolism. However, when a zinc content of drinking water exceeds a standard, it can lead to excessive zinc intake in a human body, which can cause harms to the human body, such as zinc poisoning and abnormal lipid metabolism. Therefore, the inhibition filter element 104 is configured to inhibit excessive release of zinc, a high zinc concentration can be avoided.

It can be understood that in other embodiments, the mineralization filter element 103 can further include a filter material containing other minerals, such as copper, calcium, magnesium, potassium, and strontium. It should be noted that when the mineralization filter element 103 includes the filter material containing other minerals, a corresponding inhibition filter material is matched in the inhibition filter element 104.

In an optional embodiment, the mineralization filter element 103 includes a first alkaline filter material, and the inhibition filter element 104 includes a second alkaline filter material. An alkalinity of the first alkaline filter material is less than an alkalinity of the second alkaline filter material, and the alkalinity of the second alkaline filter material is greater than the alkalinity of the first alkaline filter material. Therefore, the second alkaline filter material can be configured to suppress dissolution of an alkaline substance from the first alkaline filter material. For example, the first alkaline filter material (weakly alkaline) contains maifanite or tourmaline, and the second alkaline filter material (strongly alkaline) contains zinc with a high concentration and magnesium with a high concentration.

Weakly alkaline ores are arranged in the first alkaline filter material, and strongly alkaline ores are arranged in the second alkaline filter material. When water flows through the first alkaline filter material first, an alkaline substance precipitated from the first alkaline filter material can increase the pH value of the water. Afterwards, when the water flows into the inhibition filter element 104, since the pH value of the water has been increased by the first alkaline filter material, the precipitation of the minerals such as zinc and copper in the second alkaline filter material can be inhibited to an extent (usually because the solubility or precipitation rate of these minerals decreases at a higher pH value).

By using the above filter element unit 203, when the water has a high mineral content, the mineral content of the water can be reduced by inhibiting the release or dissolution of the minerals in the mineralization filter element through the inhibition filter element.

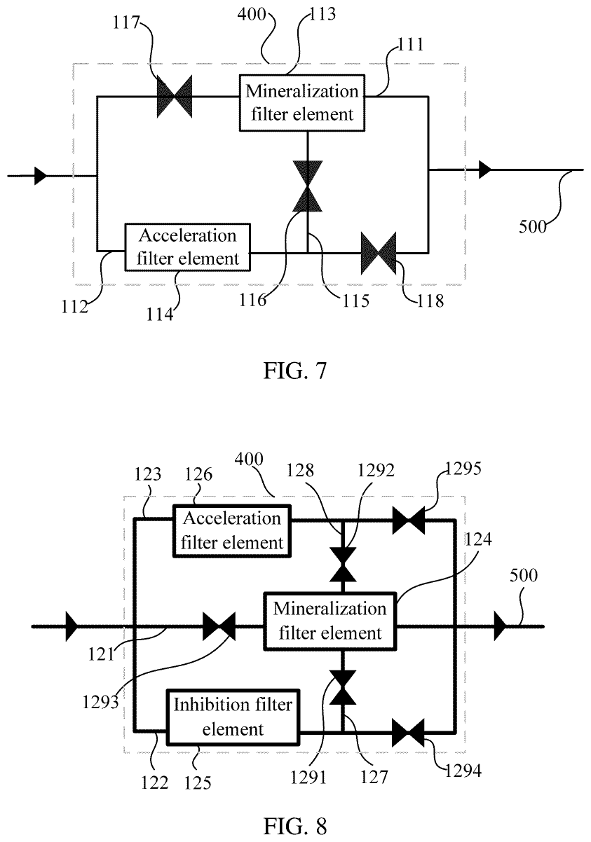

As shown in FIG. 7, the mineralization filter element unit 203 includes a mineralization pipeline 111 and an acceleration pipeline 112. The mineralization pipeline 111 is provided with a mineralization filter element 113, and the acceleration pipeline 112 is provided with an acceleration filter element 114.

In an optional embodiment, the mineralization pipeline 111 and the acceleration pipeline 112 are arranged in parallel and can simultaneously output water. Specifically, the mineralization pipeline 111 and the acceleration pipeline 112 are connected in parallel between the water inlet pipeline 109 of the mineralization filter element unit 203 and the water outlet pipeline 60 of the mineralization filter element unit 203. The water inlet pipeline 109 can be connected to the mineralization pipeline 111 and the acceleration pipeline 112 through a three-way valve or a flow divider valve, and the mineralization pipeline 111 and the acceleration pipeline 112 can be connected to the water outlet pipeline 60 through a three-way valve. When the mineralization pipeline 111 and the acceleration pipeline 112 simultaneously output water, the water from the mineralization pipeline 111 and the acceleration pipeline 112 can be mixed and then discharged through the water outlet pipeline 60.

The mineralization filter element 113 is arranged in the mineralization pipeline 111, and the mineralization filter element 113 can release (dissolve) minerals into the water flowing therethrough, thereby making the water output from the mineralization pipeline 111 contain minerals, to meet a requirement of people for mineralized water. The acceleration filter element 114 is arranged in the acceleration pipeline 112, and the acceleration filter element 114 can release an accelerant into the water flowing therethrough. When the water containing the accelerant flows through the mineralization filter element 113, the accelerant can accelerate the dissolution of the minerals in the mineralization filter element 113, thereby increasing the mineral content of the water.

In an optional embodiment, the mineralization filter element unit 203 further includes a serially-connected switching pipeline 115. The serially-connected switching pipeline 115 is arranged between the mineralization pipeline 111 and the acceleration pipeline 112 and is configured to connect the acceleration filter element 114 to the mineralization filter element 113 in series. An output end of the serially-connected switching pipeline 115 is connected to the mineralization pipeline 111 or the mineralization filter element 113, and an input end of the serially-connected switching pipeline 115 is connected to the acceleration pipeline 112 or the acceleration filter element 114.

The output end of the serially-connected switching pipeline 115 is connected to the mineralization pipeline 111 or the mineralization filter element 113, and the input end of the serially-connected switching pipeline 115 is connected to the acceleration pipeline 112 or the acceleration filter element 114, so that a mineralization

structure in which the acceleration filter element 114 is located upstream and the mineralization filter element 113 is located downstream can be formed, and the water containing the accelerant is made to flow through a waterway of the mineralization filter element 113.

Since the water containing the accelerant flows into the mineralization filter element 113, the accelerant can accelerate the release of the minerals from the mineralization filter element 113, thereby increasing the mineral content of the water and then avoiding that the mineral content of the water does not meet a standard. For example, when the flow rate of the water in the mineralization pipeline 111 exceeds a set flow rate (i.e., the flow rate of the water is large), the flow speed of the water increases, and the release amount of the minerals in water per unit volume can decrease. By using the serially-connected switching pipeline 115, the water containing the accelerant flows into the mineralization filter element 113 to accelerate the release of the minerals from the mineralization filter element 113, which can increase the mineral content of the water. When the mineralization filter element 113 has been used for a period of time and reaches the middle to late stage of its service life, the performance of the mineralization filter element 113 for releasing minerals decreases. The accelerant is used to accelerate the release of minerals from the mineralization filter element 113, so that the mineral content of the water can be effectively increased, and the minerals in the water can meet a standard. Furthermore, the service life of the mineralization filter element 113 can be prolonged.

In an optional embodiment, a first control valve 116 is arranged at the serially-connected switching pipeline 115.

The first control valve 116 has a state of allowing water to flow through and a state of not allowing water to flow through. In specific applications, the first control valve 116 can also be a flow valve. Since the first control valve 116 is arranged at the serially-connected switching pipeline 115, it is possible to control whether the water can flow through the serially-connected switching pipeline 115 from the acceleration filter element 114 to the mineralization filter element 113. When the water in the mineralization pipeline 111 has a large flow rate, or when the mineralization filter element 113 has reached the middle to late stage of its service life, the first control valve 116 can be in the state of allowing water to flow through. In this case, the water can flow from the acceleration filter element 114 to the mineralization filter element 113 through the serially-connected switching pipeline 115, thereby increasing the release amount of minerals from the mineralization filter element 113, to increase the mineral content of the water, prevent

the mineral content from being less than a set standard, and control the mineral content in a safe standard range. When the flow rate of the water in the mineralization pipeline 111 is less than a set flow rate, or when the mineralization filter element 113 has reached the middle to late stage of its service life, a concentration of the minerals in the water that flows through the mineralization filter element 113 cannot be less than a set standard. When the mineral content of the water meets the standard, the first control valve 116 can be in the state of not allowing water to flow through.

In an optional embodiment, the mineralization filter element unit 203 further includes a second control valve 117. The second control valve 117 is arranged at the mineralization pipeline 111 and is located at an upstream end of the mineralization filter element 113.

The second control valve 117 is configured to control the mineralization pipeline 111 to be in a connected or disconnected state and/or control a flow rate of the mineralization pipeline 111. By controlling opening or closing of the second control valve 117, it is possible to determine whether to convey water to the mineralization filter element 113. The flow rate of the mineralization pipeline 111 is controlled through the second control valve 117, so that an amount of minerals released by the mineralization filter element 113 into water per unit volume can be controlled. Specifically, when the flow rate of water in the mineralization pipeline 111 is greater than a set flow rate, the mineral content of water per unit volume can decrease. When the flow rate of water in the mineralization pipeline 111 is less than the set flow rate, the mineral content of water per unit volume can increase. Therefore, the flow rate of the mineralization pipeline 111 can be adjusted through the second control valve 117, thereby adjusting the mineral content of the water in the mineralization pipeline 111.

The output end of the serially-connected switching pipeline 115 is connected between the second control valve 117 and the mineralization filter element 113. In this way, the output end of the serially-connected switching pipeline 115 is connected to an upstream end of the mineralization filter element 113, which can achieve flowing of water in the serially-connected switching pipeline 115 to the mineralization filter element 113.

In an optional embodiment, the mineralization filter element unit 203 further includes a third control valve 118. The third control valve 118 is arranged at the acceleration pipeline 112 and is located at a downstream end of the acceleration filter element 114.

The third control valve 118 is configured to control the acceleration pipeline 112 to be in a connected or disconnected state and/or control a flow rate of the acceleration pipeline 112. The input end of the serially-connected switching pipeline 115 is connected between the acceleration filter element 114 and the third control valve 118. In this way, the input end of the serially-connected switching pipeline 115 is connected to the downstream end of the acceleration filter element 114. When the third control valve 118 is closed, and the first control valve 116 is opened, the water containing the accelerant can flow to the serially-connected switching pipeline 115, and then the water containing the accelerant flows to the mineralization filter element 113.

By controlling the opening or closing of the second control valve 117 and the opening or the closing of the third control valve 118, as well as controlling the state of the first control valve 116 of whether to allow water to flow through, it is possible to achieve that the mineralization pipeline 111 and the acceleration pipeline 112 output water simultaneously or separately, and the water flowing through the acceleration filter element 114 can enter the mineralization filter element 113 through the serially-connected switching pipeline 115.

For example, when the mineralization pipeline 111 and the acceleration pipeline 112 need to output water simultaneously, the second control valve 117 and the third control valve 118 can be controlled to be opened, and the first control valve 116 can be closed. In this case, the serially-connected switching pipeline 115 is blocked, and the mineralization pipeline 111 and the acceleration pipeline 112 are connected in parallel. The water containing the minerals in the mineralization pipeline 111 and the water containing the accelerant in the acceleration pipeline 112 can be mixed in the water outlet pipeline 60 and then discharged.

For another example, when the mineralization pipeline 111 needs to output water separately, the second control valve 117 can be controlled to be opened, and the first control valve 116 and the third control valve 118 can be closed. In this case, the mineralization pipeline 111 is unblocked, and the acceleration pipeline 112 and the serially-connected switching pipeline 115 are both blocked. The water containing the minerals in the mineralization pipeline 111 can be discharged through the water outlet pipeline 60.

For another example, when the mineralization filter element 113 is in the middle to late stage of its service life, the first control valve 116 can be controlled to be opened, and the second control valve 117 and the third control valve 118 can be controlled to be closed. In this case, the acceleration filter element 114 and the mineralization filter element 113 are connected through the serially-connected switching pipeline 115, and the water containing the accelerant can flow to the mineralization filter element 113 through the serially-connected switching pipeline 115, thereby accelerating the release of minerals from the mineralization filter element 113, to make the minerals in the water meet the standard. Even if the mineralization filter element 113 is in the middle to late stage of its lifespan (the dissolution rate of minerals decreases), by using the acceleration filter element 114, the dissolution rate of the minerals in the mineralization filter element 113 is maintained within a set range, and the service life of the mineralization filter element 113 can be prolonged. Or, even in a large flow rate, the first control valve 116 can be controlled to be opened, and the second control valve 117 and the third control valve 118 can be controlled to be closed, so that the minerals in the water can meet the standard at the large flow rate.

In an optional embodiment, the first control valve 116, the second control valve 117, and the third control valve 118 are all electromagnetic valves. Of course, in other embodiments, the first control valve 116, the second control valve 117, and the third control valve 118 can further use other valves.

In an optionally embodiment, the mineralization filter element 113 includes a metasilicic-acid-containing filter material, and the acceleration filter element 114 includes an alkaline filter material. Silicon is one of the essential trace elements for a human body, and it tends to decrease significantly with age in the human body. Modern medicine has shown that silicon has an impact on synthesis of bone tissues and is related to bone growth and bone structures. Silicon plays a physiological role in the process of bone calcification and can promote bone growth. Insufficient intake of silicon can lead to a decrease in bone calcium content. Lack of silicon in a body can further lead to growth retardation, resulting in skeletal abnormalities, deformities (especially in the skull), and underdeveloped teeth or enamel. Silicon can further enhance the strength of elastic fibers of blood vessels, especially intimal elastic layers, thereby forming a barrier that effectively hinders lipid invasion. This property enables silicon to have an effect of resisting atherosclerosis, can maintain the integrity of the elastic fibers and mesenchyme, and thus prevent formation of atherosclerotic plaques. Silicon can further remove fat deposited on inner walls of blood vessels. This mechanism can alleviate arteriosclerosis and cardiovascular and heart diseases.

Silicon required by a human body generally comes from water, and the silicon in the water exists in the form of metasilicic acid, so that it is easily absorbed by the human body and the skin. Therefore, since the mineralization filter element 113 contains the metasilicic-acid-containing filter material, the mineralization filter element 113 can release metasilicic acid into the water, which is beneficial to the health of the human body.

In addition, water with a pH value between 7.0 and 9.0 is the best for the health of the human body. Configuring the acceleration filter element 114 to include the alkaline filter material is beneficial for maintaining the water within the pH range of 7.0 to 9.0, which is then beneficial to the health of the human body.

It can be understood that in other embodiments, the mineralization filter element 113 can further include a filter material containing other minerals, such as copper, calcium, magnesium, potassium, strontium, and zinc. It should be noted that when the mineralization filter element 113 includes the filter material containing other minerals, a corresponding acceleration filter material is matched in the acceleration filter element 114.

In an optional embodiment, the mineralization filter element 113 includes maifanite, and the acceleration filter element 114 includes periclase. By using the maifanite as the filter material of the mineralization filter element 113, the metasilicic acid that is beneficial for the human body can be released, without producing harmful substances to the human body.

By using the above filter element unit 203, when the water has a low mineral content, the mineral content of the water can be increased by accelerating the release or dissolution of the minerals in the mineralization filter element through the acceleration filter element.

As shown in FIG. 8, the mineralization filter element unit 203 includes a mineralization pipeline 121, an inhibition pipeline 122, and an acceleration pipeline 123. The mineralization pipeline 121 is provided with a mineralization filter element 124. The inhibition pipeline 122 is provided with an inhibition filter element 125. The acceleration pipeline 123 is provided with an acceleration filter element 126.

In an optional embodiment, the mineralization pipeline 121, the inhibition pipeline 122, and the acceleration pipeline 123 are arranged in parallel and can simultaneously output water. Specifically, the mineralization pipeline 121, the inhibition pipeline 122, and the acceleration pipeline 123 are connected in parallel between the water inlet pipeline 109 of the mineralization filter element unit 203 and the water outlet pipeline 60 of the mineralization filter element unit 203. The water inlet pipeline 109 can be connected to the mineralization pipeline 121, the inhibition pipeline 122, and the acceleration pipeline 123 through a multi-way valve or a flow divider valve, and the mineralization pipeline 121, the inhibition pipeline 122, and the acceleration pipeline 123 can be connected to the water outlet pipeline 60 through a multi-way valve. When the mineralization pipeline 121, the inhibition pipeline 122, and the acceleration pipeline 123 simultaneously output water, the water from the mineralization pipeline 121, the inhibition pipeline 122, and the acceleration pipeline 123 can be mixed and then discharged through the water outlet pipeline 60.

The mineralization filter element 124 is arranged in the mineralization pipeline 121, and the mineralization filter element 124 can release (dissolve) minerals into the water flowing therethrough, thereby making the water output from the mineralization pipeline 121 contain minerals, to meet a requirement of people for mineralized water. The inhibition filter element 125 is arranged in the inhibition pipeline 122, and the inhibition filter element 125 can release an inhibitory substance into the water flowing therethrough. When the water containing the inhibitory substance flows through the mineralization filter element 124, the inhibitory substance can inhibit the dissolution of the minerals in the mineralization filter element 124, thereby avoiding a situation that the mineral content of the water is high. The acceleration filter element 126 is arranged in the acceleration pipeline 123, and the acceleration filter element 126 can release an accelerant into the water flowing therethrough. When the water containing the accelerant flows through the mineralization filter element 124, the accelerant can accelerate the dissolution of the minerals in the mineralization filter element 124, thereby increasing the mineral content of the water.

In an optional embodiment, the mineralization filter element unit 203 further includes a first connection pipeline 127. The first connection pipeline 127 is arranged between the mineralization pipeline 121 and the inhibition pipeline 122 and is configured to connect the inhibition filter element 125 to the mineralization filter element 124 in series. An output end of the first connection pipeline 127 is connected to the mineralization pipeline 121 or the mineralization filter element 124, and an input end of the first connection pipeline 127 is connected to the inhibition pipeline 122 or the inhibition filter element 125. In this way, a mineralization structure in which the inhibition filter element 125 is located upstream and the mineralization filter element 124 is located downstream can be formed, and the water containing the inhibitory substance flows through a waterway of the mineralization filter element 124.

In an optional embodiment, the mineralization filter element unit 203 further includes a second connection pipeline 128. The second connection pipeline 128 is arranged between the mineralization pipeline 121 and the acceleration pipeline 123 and is configured to connect the acceleration filter element 126 to the mineralization filter element 124 in series. An output end of the first connection pipeline 127 is connected to the mineralization pipeline 121 or the mineralization filter element 124, and an input end of the first connection pipeline 127 is connected to the acceleration pipeline 123 or the acceleration filter element 126. In this way, a mineralization structure in which the promotion filter element 126 is located upstream and the mineralization filter element 124 is located downstream can be formed, and the water containing the accelerant flows through the waterway of the mineralization filter element 124.

In an optional embodiment, a first control valve 1291 is arranged at the first connection pipeline 127. The first control valve 1291 has a state of allowing water to flow through and a state of not allowing water to flow through. In specific applications, the first control valve 1291 can also be a flow valve.

In an optional embodiment, a second control valve 1292 is arranged at the second connection pipeline 128. The second control valve 1292 has a state of allowing water to flow through and a state of not allowing water to flow through. In specific applications, the second control valve 1292 can also be a flow valve.

In an optional embodiment, the mineralization pipeline 121 is provided with a third control valve 1293 for controlling the mineralization pipeline 121 to be in a connected or disconnected state and/or for controlling a flow rate of the mineralization pipeline 121. The third control valve 1293 is arranged at an upstream end of the mineralization filter element 124.

In an optional embodiment, the inhibition pipeline 122 is provided with a fourth control valve 1294 for controlling the inhibition pipeline 122 to be in a connected or disconnected state and/or for controlling a flow rate of the inhibition pipeline 122. Since

the fourth control valve 1294 is arranged at the downstream end of the inhibition filter element 125, it can be achieved whether to convey water to the inhibition filter element 125 by controlling opening or closing of the fourth control valve 1294.

In an optional embodiment, the acceleration pipeline 123 is provided with a fifth control valve 1295 for controlling the acceleration pipeline 123 to be in a connected or disconnected state and/or for controlling a flow rate of the acceleration pipeline 123. Since the fifth control valve 1295 is arranged at the downstream end of the acceleration filter element 126, it can be achieved whether to convey water to the acceleration filter element 126 by controlling opening or closing of the fifth control valve 1295.

One end of the first connection pipeline 127 is connected between the third control valve 1293 and the mineralization filter element 124, and the other end of the first connection pipeline 127 is connected between the inhibition filter element 125 and the fourth control valve 1294. Since the third control valve 1293 is arranged at the upstream end of the mineralization filter element 124 and the fourth control valve 1294 is arranged at the downstream end of the inhibition filter element 125, the input end of the first connection pipeline 127 is connected to the downstream end of the inhibition filter element 125, and the output end of the first connection pipeline 127 is connected to the upstream end of the mineralization filter element 124. When the third control valve 1293 and the fourth control valve 1294 are controlled to be closed, and the first control valve 1291 is in the state of allowing water to flow through, the water containing the inhibitory substance can flow to the first connection pipeline 127 and then to the mineralization filter element 124.

One end of the second connection pipeline 128 is connected between the third control valve 1293 and the mineralization filter element 124, and the other end of the second connection pipeline 128 is connected between the acceleration filter element 126 and the fifth control valve 1295. Since the third control valve 1293 is arranged at the upstream end of the mineralization filter element 124 and the fifth control valve 1295 is arranged at the downstream end of the acceleration filter element 126, the input end of the second connection pipeline 128 is connected to the downstream end of the acceleration filter element 126, and the output end of the second connection pipeline 128 is connected to the upstream end of the mineralization filter element 124. When the third control valve 1293 and the fifth control valve 1295 are controlled to be closed, and the second control valve 1292 is in the state of allowing water to flow through, the water containing the accelerant can flow to the second connection pipeline 128 and then to the mineralization filter element 124.

By controlling the opening or closing of the first control valve 1291, the second control valve 1292, the third control valve 1293, the fourth control valve 1294, and the fifth control valve 1295, at least two of the mineralization pipeline 121, the inhibition pipeline 122, and the acceleration pipeline 123 can be simultaneously or separately output water, and the water flowing through the inhibition filter element 125 can enter the mineralization filter element 124 through the first connection pipeline 127, or the water flowing through the acceleration filter 126 can enter the mineralization filter element 124 through the second connection pipeline 128, to make pipeline structures meet different requirements.

For example, when the mineralization pipeline 121, the inhibition pipeline 122, and the acceleration pipeline 123 need to output water simultaneously, the third control valve 1293, the fourth control valve 1294, and the fifth control valve 1295 can be controlled to be opened, and the first control valve 1291 and the second control valve 1292 can be controlled to be in the state of not allowing water to pass through. In this case, the first connection pipeline 127 and the second connection pipeline 128 are both blocked, and the mineralization pipeline 121, the inhibition pipeline 122, and the acceleration pipeline 123 are connected in parallel between the water inlet pipeline 109 and the water outlet pipeline 60 and are arranged in parallel. The water in the mineralization pipeline 121, the water in the inhibition pipeline 122, and the water in the acceleration pipeline 123 are discharged after being mixed in the water outlet pipeline 60.

For example, when the mineralization filter element 124 is in the soaked state, the first control valve 1291 can be controlled to be in the state of allowing water to flow through; the second control valve 1292 can be controlled to be in the state of not allowing water to flow through; and the third control valve 1293, the fourth control valve 1294, and the fifth control valve 1295 can be controlled to be closed. In this way, both the second connection pipeline 128 and the acceleration pipeline 123 are blocked. The inhibition filter element 125 and the mineralization filter element 124 are connected through the first connection pipeline 127. The water containing the inhibitory substance can flow through the first connection pipeline 127 to the mineralization filter element 124, thus allowing the water containing the inhibitory substance to enter and fill the mineralization filter element 124. The mineralization filter element 124 can be soaked in the water containing the inhibitory substance.

For example, in order to prevent an excessive mineral content caused by soaking of the mineralization filter element 124, the first control valve 1291 can be controlled to be in the state of allowing water to flow through; the second control valve 1292 can be controlled to be in the state of not allowing water to flow through; the third control valve 1293 and the fourth control valve 1294 can be controlled to be closed; and the fifth control valve 1295 can be controlled to be opened. In this case, the second connection pipeline 128 is blocked. The inhibition filter element 125 and the mineralization filter element 124 are connected through the first connection pipeline 127. The water containing the inhibitory substance can flow to the mineralization filter element 124 through the first connection pipeline 127, thereby inhibiting the release of minerals from the mineralization filter element 124 and preventing the mineral content of the water from exceeding a standard content. The acceleration pipeline 123 is unblocked, so that the water containing the accelerant can flow to the water outlet pipeline 60. The acceleration filter element 126 can include a filter material that releases minerals, thereby adding the new kind of mineral into the water. For example, the acceleration filter element 126 includes a periclase filter material described below. The periclase filter material is an alkaline filter material, and released (dissolved) periclase can adjust the pH value of water, to improve the taste of drinking water and maintain a healthy state of a human body.

For example, when the mineralization filter element 124 is the middle to late stage of its service life, the first control valve 1291 can be controlled to be in the state of not allowing water to flow through; the second control valve 1292 can be controlled to be in the state of allowing water to flow through; and the third control valve 1293, the fourth control valve 1294, and the fifth control valve 1295 can be controlled to be closed. In this case, both the first connection pipeline 127 and the inhibition pipeline 122 are blocked, and the acceleration filter element 126 and the mineralization filter element 124 are connected through the second connection pipeline 128. The water containing the accelerant can flow to the mineralization filter element 124 through the second connection pipeline 128, thereby accelerating the release of minerals from the mineralization filter element 124 and ensuring that the minerals in the water can meet a standard. Even if the mineralization filter element 124 is in the middle to late stage of its lifespan (the dissolution rate of minerals decreases), by using the acceleration filter element 126, the dissolution rate of the minerals in the mineralization filter element 124 is maintained within a set range, and the service life of the mineralization filter element 124 can be prolonged. Or, in an expected large flow rate, the first control valve 1291 can be controlled to be in the state of not allowing water to flow through; the second control valve 1292 can be controlled to be in the state of allowing water to flow through; and the third control valve 1293, the fourth control valve 1294, and the fifth control valve 1295 can be controlled to be closed, so that the minerals in the water can meet the standard at the large flow rate.

For example, in an expected large flow rate, when a new kind of mineral is added into the water, the first control valve 1291 can be controlled to be in the state of not allowing water to flow through; the second control valve 1292 can be controlled to be in the state of allowing water to flow through; the third control valve 1293 and the fifth control valve 1295 can be controlled to be closed; and the fourth control valve 1294 can be controlled to be opened. In this case, the first connection pipeline 127 is blocked. The promotion filter element 126 and the mineralization filter element 124 are connected through the second connection pipeline 128. The water containing the accelerant can flow to the mineralization filter element 124 through the second connection pipeline 128, thereby promoting the release of minerals from the mineralization filter element 124, to make the minerals in the water to meet the standard. The inhibition pipeline 122 is unblocked, so that the water containing the inhibitory substance can flow to the water outlet pipeline 60. The inhibition filter element 125 can include a filter material that releases minerals, thereby adding the new kind of mineral into the water. For example, the inhibition filter element 125 includes a zeolite filter material described below. Zeolite released (dissolved) by the zeolite filter material can adsorb harmful substances such as heavy metals, ammonium, and hydrogen compounds in water, which greatly improves the water quality. In addition, zeolite can further adjust the pH value of water, to improve the taste of drinking water and maintain a healthy state of a human body.

In an optional embodiment, the first control valve 1291, the second control valve 1292, the third control valve 1293, the fourth control valve 1294, and the fifth control valve 1295 are all electromagnetic valves. Of course, in other embodiments, the first control valve 1291, the second control valve 1292, the third control valve 1293, the fourth control valve 1294, and the fifth control valve 1295 can further use other valves.

In an optionally embodiment, the mineralization filter element 124 includes a metasilicic-acid-containing filter material; the inhibition filter element 125 includes a zeolite filter material; and the acceleration filter element 126 includes an alkaline filter material. In other embodiments, the mineralization filter element 124 can further include a filter material containing other minerals, such as copper, calcium, magnesium, potassium, strontium, and zinc. It should be noted that when the mineralization filter element 124 includes the filter material containing other minerals, a corresponding acceleration filter material is matched in the acceleration filter element 126, and a corresponding inhibition filter material is matched in the inhibition filter element 125.

In an optional embodiment, the mineralization filter element 124 includes maifanite; the acceleration filter element 126 includes periclase; and the inhibition filter element 125 includes zeolite.

By using the above filter element unit 203, the water containing the inhibitory substance is conveyed to the mineralization filter element 124, to inhibit the release of minerals from the mineralization filter element 124, thereby preventing an excessive mineral content of the water. Furthermore, the water containing the accelerant is conveyed to the mineralization filter element 124 to accelerate the release of minerals from the mineralization filter element 124, to prevent the phenomenon that the mineral content of the water does not meet the standard.

In an optional embodiment, conductivity detection members 10 are installed upstream and downstream of the mineralization filter element unit 400, respectively, for real-time detection of conductivity value upstream and downstream of the mineralization filter element unit 400. The conductivity detection members 10 upstream and downstream transmit their respective detected conductivity value to the control member 410. After obtaining the conductivity value upstream and downstream of the mineralization filter element unit 400, the control member 410 can calculate a pH value of the water based on the upstream and downstream conductivity value.

In one embodiment, the control member 410 can calculate a conductivity difference based on the upstream and downstream conductivity data and obtain the pH value of the water filtered out by the mineralization filter element unit 400 according to a corresponding relationship between preset conductivity differences and pH values. The corresponding relationship is a mathematical function obtained by fitting a relationship between the conductivity differences and the pH values using a data fitting method (such as linear regression, polynomial regression, and a machine learning algorithm).

If the pH value of the water is lower than a preset pH threshold (indicating insufficient mineralization), the power supply member 420 will be controlled to increase the forward voltage applied to the single-channel desalination component 200. This will improve a desalination efficiency of the single-channel desalination component 200, thereby reducing a salt content in the purified water entering the mineralization filter element unit 400 and ultimately improving a mineralization effect.

If the pH value of the water is higher than the preset pH threshold (indicating potential over-mineralization or aging of the mineralization filter element), the power supply member 420 will be controlled to reduce the forward voltage applied, to the single-channel desalination component 200 or switch to the reverse voltage. This will decrease the desalination efficiency of the single-channel desalination component 200, or increase a flushing frequency of the single-channel desalination component 200, thereby promoting the regeneration of the single-channel desalination component 200 and reducing a blockage of the mineralization filter element unit 400 by salt.

In other embodiments, the control member 410 can also control the opening and closing of various control valves in the mineralization filter element unit 400 based on the conductivity value detected by the conductivity detection member 10, thereby ensuring that the pH value of the water filtered out by the mineralization filter element unit 400 remains within a preset pH threshold range. For example, if the pH value of the water is low, the release of the minerals will be increased. If the pH value of the water is high, the release of the minerals will be decreased.

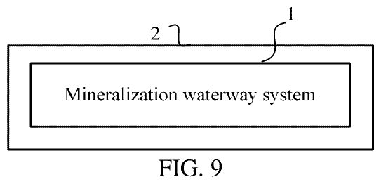

Referring to FIG. 9, a schematic structural diagram of a mineralization water purifier 2 according to an embodiment of the present disclosure is shown. The mineralization water purifier 2 includes a mineralization waterway system 1.

For the mineralization waterway system 1, refer to FIG. 1 to FIG. 8 and their related descriptions.

It should be understood that the various variations and specific embodiments of the mineralization waterway system 1 provided in the above embodiments are also applicable to the mineralization water purifier 2 in this embodiment. Through the detailed description of the mineralization waterway system 1, those skilled in the art can clearly understand an implementation process of the mineralization water purifier 2 in this embodiment. For the sake of simplicity of the specification, it will not be described in detail here.

The mineralization waterway system and the mineralization water purifier provided in the embodiments of the present disclosure achieve efficient purification of raw water through the single-channel desalination component and the dual-channel desalination component which are arranged in parallel. The dual-channel desalination component first performs preliminary desalination, and the produced pure water then flows into the single-channel desalination component for further purification, ensuring that the quality of the outlet water meets the high standards. At the same time as the pure water from the dual-channel desalination component flows into the single-channel desalination component, the saline substances within the single-channel desalination component are flushed out by the pure water and discharged through the branch pipeline, achieving self-cleaning and regeneration of the single-channel desalination component. This not only prolongs the service life of the single-channel desalination component, but also ensures the continuous stability of the quality of the outlet water. The pure water passing through the desalination components flows into the mineralization filter element unit for mineralization. The mineralization filter element unit can add beneficial minerals to the pure water, making the outlet water not only pure but also rich in mineral elements beneficial to the human body, thereby improving the quality and taste of the drinking water.

Furthermore, the connection of the branch pipeline to the first port of the single-channel desalination component provides convenience for waterway switching in the mineralization waterway system. When needed, a path of the water flow can be changed by adjusting the waterway switching device to achieve different working modes. For example, when regeneration and flushing of the single-channel desalination component is required, the water flow can be directed to the branch pipeline through the waterway switching device, avoiding interference with the normal outlet water quality.

It can be understood that the mineralization waterway system according to the embodiments of the present disclosure includes hardware structures and/or software members corresponding to the execution of various functions. The embodiments of the present disclosure can be implemented in the form of hardware or a combination of hardware and computer software in combination with units and algorithm steps of the various examples described in the embodiments of the present disclosure. Whether a function is implemented in hardware or in a manner of driving hardware by computer software depends on particular applications and design constraint conditions of the technical solutions. A person skilled in the art can use different methods to implement the described functions for each particular application, but it should not be considered that this implementation goes beyond the scope of the technical solutions of the embodiments of the present disclosure.

It can be understood that “plurality” in the embodiments of the present disclosure mean two or more, and other quantifiers are similar to it. The term “and/or” describes an association relationship of associated objects, representing that three relationships can exist. For example, A and/or B can represent three situations: A exists alone; A and B exist simultaneously; and B exists alone. The character “/” usually indicates an “or” relation between associated objects. The singular forms of “one” and “the” are also intended to include a plural form, unless the context clearly indicates other meanings.

It can be further understood that the terms “first”, “second”, and the like are used for describing various information, but the information should be not limited by these terms. These terms are only used to distinguish information of the same type from each other, and do not represent a particular order or importance. Actually, the terms “first”, “second”, and the like can be completely interchanged for use. For example, without departing from the scope of the embodiments of the present disclosure, first information can also be referred to as second information, and similarly, second information can also be referred to as first information.

Further, it can be understood that orientations or positional relationships indicated by the terms “center”, “longitudinal”, “transverse”, “front”, “rear”, “upper”, “lower”, “left”, “right”, “vertical”, “horizontal”, “top”, “bottom”, “inner”, “outer”, and the like are orientations or positional relationships as shown in the drawings, and are only for the purpose of facilitating and simplifying the descriptions of this embodiment instead of indicating or implying that devices or elements indicated must have particular orientations, and be constructed and operated in the particular orientations.

It can be further understood that, unless otherwise specified, “connection” includes direct connections between two entities without any other modules between them, as well as indirect connections between two entities with other modules between them.

It can be further understood that although the operations are described in a specific order in the accompanying drawings in the embodiments of the present disclosure, they should not be understood as requiring the execution of these operations in the specific order or serial order shown, or requiring the execution of all the operations shown to achieve the desired results. In a specific environment, multitasking and parallel processing can be advantageous.

Those skilled in the art will easily come up with other implementations of the embodiments of the present disclosure after considering this specification and implementing the invention disclosed here. The present disclosure aims to cover any variations, uses, or adaptive changes of the embodiments of the present disclosure, and these variations, uses, or adaptive changes follow the general principles of the embodiments of the present disclosure and include common knowledge or customary technical means in the technical field that are not disclosed in the embodiments of the present disclosure. This specification and the embodiments are considered as merely exemplary, and the real scope and spirit of the embodiments of the present disclosure are pointed out in the following claims.

It should be understood that the embodiments of the present disclosure are not limited to the precise structures that have been described above and shown in the drawings, and various modifications and changes can be made without departing from the scope of the present disclosure. The scope of the embodiments of the present disclosure is subject only to the appended claims.

What is claimed is:

1. A mineralization waterway system, comprising:
a water inlet pipeline, a water outlet pipeline, and a branch pipeline;
a single-channel desalination component and a dual-channel desalination component which are arranged in parallel; wherein the single-channel desalination component comprises a first port and a second port, the dual-channel desalination component comprises a water inlet side and a water outlet side, the first port and the water inlet side are arranged in parallel, the second port and the water outlet side are arranged in parallel;
a mineralization filter element unit;
wherein the water inlet pipeline is connected to the first port and the water inlet side, pure water flowing out of the second port and the water outlet side flows into the mineralization filter element unit for mineralization, and the mineralized water filtered out by the mineralization filter element unit flows out through the water outlet pipeline; the branch pipeline is connected to the first port; the dual-channel desalination component purifies the water flowing in through the water inlet side, and the pure water flows into the single-channel desalination component through the water outlet side and the second port, and salt substances within the single-channel desalination component are flushed by the pure water and then flow into the branch pipeline through the first port.

2. The mineralization waterway system according to claim 1, further comprising a waterway switching device, wherein the waterway switching device is connected to the first port, when a forward voltage is applied to the single-channel desalination component and the waterway switching device is switched to the water inlet pipeline, the single-channel desalination component purifies water flowing out through the water inlet pipeline and the first port, and the purified water flows out to the mineralization filter element unit through the second port; when the single channel desalination component is powered off or a reverse voltage is applied to the single-channel desalination component, and the waterway switching device is switched to the branch pipeline, the salt substances within the single-channel desalination component are flushed by the water flowing out through the water outlet side and the second port and then flow into the branch pipeline.

3. The mineralization waterway system according to claim 2, further comprising a power supply member and a control member, wherein the control member is configured to control the power supply member to disconnect the power supply to the single-channel desalination component or apply a reverse voltage to the single-channel desalination component, and also to control the waterway switching device to switch to the branch pipeline.

4. The mineralization waterway system according to claim 3, further comprising filtration members, wherein the filtration members are installed on the water inlet pipeline and/or the water outlet pipeline, and/or on one side of the first port of the single-channel desalination component, and/or on one side of the second port of the single-channel desalination component.

5. The mineralization waterway system according to claim 4, further comprising conductivity detection members, wherein the conductivity detection members are installed on the water inlet pipeline and/or the water outlet pipeline, and/or on the branch pipeline, and/or on one side of the second port of the single-channel desalination component, and/or on one side of the water outlet side of the dual-channel desalination component.

6. The mineralization waterway system according to claim 1, further comprising a drive member, wherein the drive member is configured to drive water flow towards the single-channel desalination component and the dual-channel desalination component.

7. The mineralization waterway system according to claim 6, further comprising a heating member, wherein the heating member is installed on the outlet water pipeline, and configured to heat water flowing out from the outlet water pipeline.

8. The mineralization waterway system according to claim 7, further comprising a temperature detection member, wherein the temperature detection member is installed on the water outlet pipeline, and configured to detect a temperature of the water flowing out from the outlet water pipeline.

9. The mineralization waterway system according to claim 1, further comprising a water flow rate detection member, wherein the water flow rate detection member is installed on the water inlet pipeline and/or the water outlet pipeline.

10. The mineralization waterway system according to claim 1, further comprising conductivity detection members, wherein the conductivity detection members are installed upstream and downstream of the mineralization filter element unit, for real-time detection of conductivity value upstream and downstream of the mineralization filter element unit.

11. The mineralization waterway system according to claim 1, wherein the mineralization filter element unit comprises a mineralization pipeline, and a mineralization filter element is arranged on the mineralization pipeline.

12. The mineralization waterway system according to claim 1, wherein the mineralization filter element unit comprises: a mineralization pipeline and an inhibition pipeline which are arranged in parallel and capable of simultaneously or separately discharging water; the mineralization pipeline is provided with a mineralization filter element; the inhibition pipeline is provided with an inhibition filter element; a serially-connected switching pipeline is arranged between the mineralization pipeline and the inhibition pipeline; the serially-connected switching pipeline is configured to connect the inhibition filter element to the mineralization filter element in series; an output side of the serially-connected switching pipeline is connected to the mineralization pipeline or the mineralization filter element; an input side of the serially-connected switching pipeline is connected to the inhibition pipeline or the inhibition filter element; and a control valve is arranged on the serially-connected switching pipeline.

13. The mineralization waterway system according to claim 12, wherein the mineralization filter element comprises a zinc-containing filter material; and the inhibition filter element comprises an alkaline filter material.

14. The mineralization waterway system according to claim 12, wherein the mineralization filter element comprises a first alkaline filter material; the inhibition filter element comprises a second alkaline filter material; and the second alkaline filter material is configured to inhibit dissolution of an alkaline substance from the first alkaline filter material.

15. The mineralization waterway system according to claim 1, wherein the mineralization filter element unit comprises: a mineralization pipeline and an acceleration pipeline which are arranged in parallel and capable of simultaneously or separately discharging water; the mineralization pipeline is provided with a mineralization filter element; the acceleration pipeline is provided with an acceleration filter element; a serially-connected switching pipeline is arranged between the mineralization pipeline and the acceleration pipeline; the serially-connected switching pipeline is configured to connect the acceleration filter element to the mineralization filter element in series; an output side of the serially-connected switching pipeline is connected to the mineralization pipeline or the mineralization filter element; an input side of the serially-connected switching pipeline is connected to the acceleration pipeline or the acceleration filter element; and a control valve is arranged on the serially-connected switching pipeline.

16. The mineralization waterway system according to claim 15, wherein the mineralization filter element comprises a metasilicic-acid-containing filter material, and the acceleration filter element comprises an alkaline filter material.

17. The mineralization waterway system according to claim 16, wherein the mineralization filter element comprises maifanite, and the acceleration filter element comprises periclase.

18. The mineralization waterway system according to claim 1, wherein the mineralization filter element unit comprises: a mineralization pipeline, an inhibition pipeline, and an acceleration pipeline which are arranged in parallel and capable of simultaneously or separately discharging water; the mineralization pipeline is provided with a mineralization filter element; the inhibition pipeline is provided with an inhibition filter element; the acceleration pipeline is provided with an acceleration filter element; a first connection pipeline is arranged between the mineralization pipeline and the inhibition pipeline; an output side of the first connection pipeline is connected to the mineralization pipeline or the mineralization filter element; an input side of the first connection pipeline is connected to the inhibition pipeline or the inhibition filter element; a first control valve is arranged at the first connection pipeline; a second connection pipeline is arranged between the mineralization pipeline and the acceleration pipeline; an output side of the second connection pipeline is connected to the mineralization pipeline or the mineralization filter element; an input side of the second connection pipeline is connected to the acceleration pipeline or the acceleration filter element; and a second control valve is arranged at the second connection pipeline.

19. The mineralization waterway system according to claim 18, wherein the mineralization filter element comprises a metasilicic-acid-containing filter material; the acceleration filter element comprises an alkaline filter material; and the inhibition filter element comprises a zeolite filter material.

20. A mineralization water purifier, comprising the mineralization waterway system according to claim 1.
